(19) United States
(12) Patent Application Publication
(10) Pub. No.: US 2011/0110604 A1
(43) Pub. Date: May 12, 2011

(54) CROPPING SCANNED PAGES TO REMOVE ARTIFACTS

(76) Inventor: Prakash Reddy, Fremont, CA (US)

(21) Appl. No.: 12/615,771

(22) Filed: Nov. 10, 2009

(51) Int. Cl. G06K 9/40

(52) U.S. Cl. 382/275; 382/282; 382/286; 382/289

(57) ABSTRACT

One embodiment is a method that crops a scanned page of a document to remove an artifact.

### CROSS-REFERENCE TO RELATED APPLICATIONS

This patent application is related to U.S. patent application entitled “System and Method for Removing Artifacts from a Digitized Document” filed on 27 Jan. 2009 and having Ser. No. 12/360,807, which is incorporated herein by reference.

### BACKGROUND

Millions of books, magazines, and other documents exist that do not have a corresponding digital or electronic version. A digital copy of such documents is often desired for online viewing and retail, such as books being sold as print on demand.

In order to create a digital copy, the documents are scanned. During the scanning process, however, artifacts and other anomalies can be introduced into the digital copy. Examples of artifacts introduced during the scanning process include shadows, gutter lines, and misalignment of borders.

Artifacts and other anomalies introduced during the scanning process should be removed in order to produce legible and clean copies of the scanned documents.

### BRIEF DESCRIPTION OF THE DRAWINGS

FIG. 1 shows a method to align content of scanned pages in accordance with an example embodiment of the present invention.

FIG. 2A shows a scanned page with artifacts and misaligned content in accordance with an example embodiment of the present invention.

FIG. 2B shows a scanned page with coordinates being generated on the page in accordance with an example embodiment of the present invention.

FIG. 2C shows a scanned page after content is cropped in accordance with an example embodiment of the present invention.

FIG. 2D shows a blank page before receiving the content in accordance with an example embodiment of the present invention.

FIG. 2E shows a blank page with content aligned on the page and artifacts removed in accordance with an example embodiment of the present invention.

FIG. 2F shows a page with locations to place cropped content in accordance with an example embodiment of the present invention.

FIG. 3 shows a computer system in accordance with an example embodiment of the present invention.

FIG. 4 shows a method applied when page sizes differ along a Y-axis in accordance with an example embodiment of the present invention.

### DETAILED DESCRIPTION

Embodiments relate to systems, methods, and apparatus that align cropped content on pages that are scanned from documents.

During the scanning process, artifacts and other anomalies can be introduced into the digital copy of a document. Example embodiments remove such artifacts and anomalies to produce legible and clean digital copies of the scanned documents.

One example embodiment automatically aligns and flattens scanned text of documents (such as current and out-of print-books), cleans and brightens the fold and corners of the pages for consistent coloration, and outputs a print-ready version of the document, such as a Portable Document Format (PDF) version of the document. This print-ready version represents a replica or copy of the document as it originally existed. For example, an out-of-print book can be digitally reproduced so pages can be displayed or even reprinted as they originally appeared in an original hard copy version of the book. The book is thus digitally reproduced in its original form.

Once a document is reproduced according with example embodiments, the document can stored, displayed, transmitted, sold, etc. For example, digital copies of books and magazines enable cost-effective printing and binding of the books and magazines at a point of sale (such as over the internet or at a website) and/or on demand. Consumers have access to scanned documents and previously unavailable print media as a high quality replica of the original.

One embodiment is an imaging algorithm that turns scanned documents into a restored or clean digital form. For example, older or rare books can include yellowed or damaged pages. When these books are scanned, these pages do not appear in their original form since the scanned images include artifacts, such as the yellowing or damaged pages. The scanning process itself can also introduce artifacts, such as gray areas, black marks, misaligned borders or edges, binding marks, etc. Example embodiments remove the artifacts, cure any misalignment issues, and generate a new scanned image that represents a replica of the original book (i.e., a restored version without the yellowed or damaged pages and other artifacts).

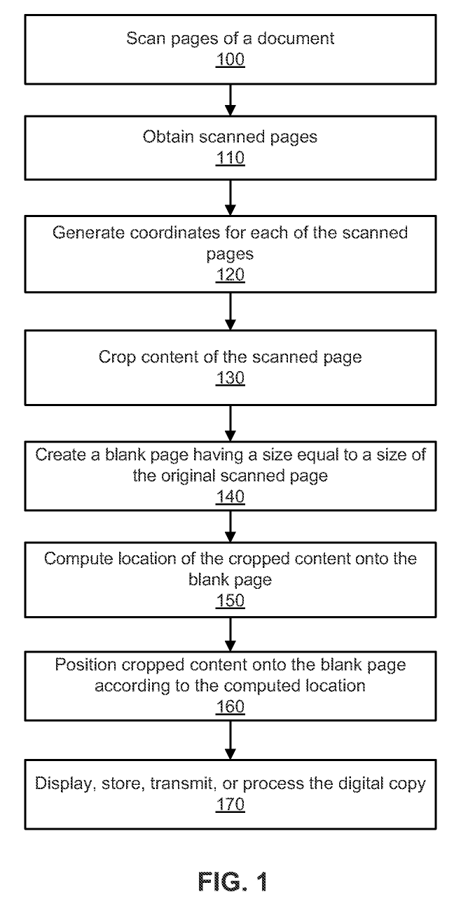

FIG. 1 is a method to align content of scanned pages according to an example embodiment. In one embodiment, the method aligns cropped content on blank pages to preserve or reproduce an original position of the document. The processed document can be viewed and printed to reproduce a replicate of the original document without the addition of artifacts or other anomalies.

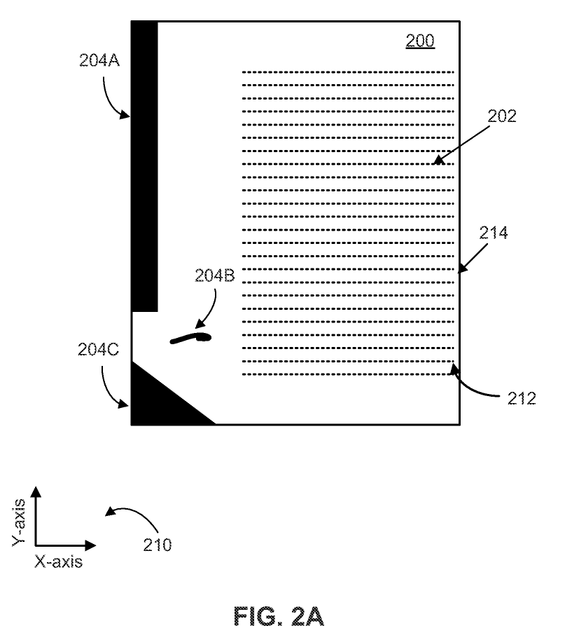

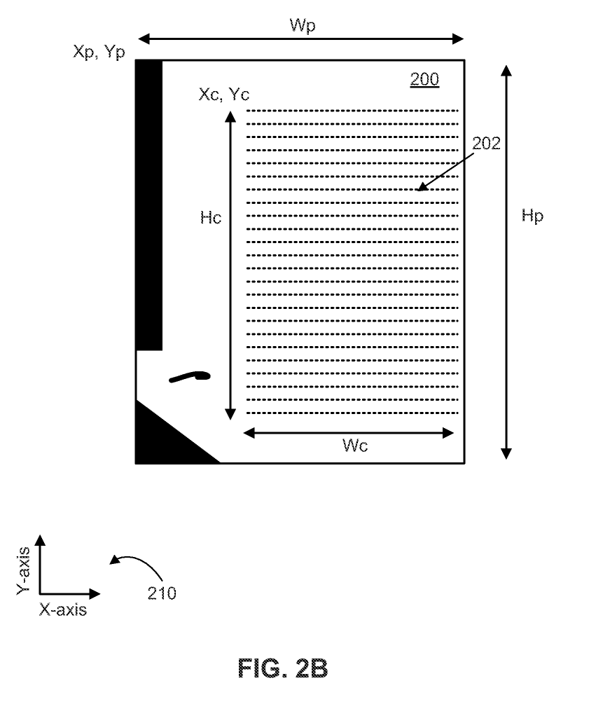

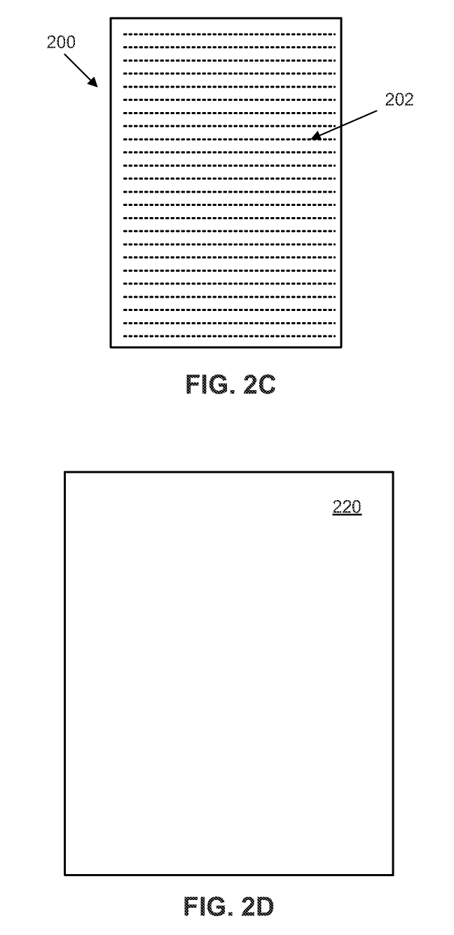

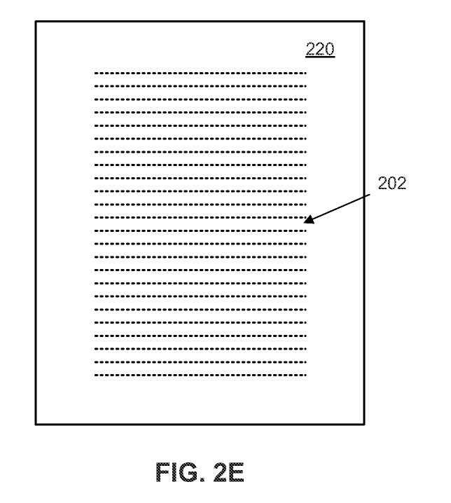

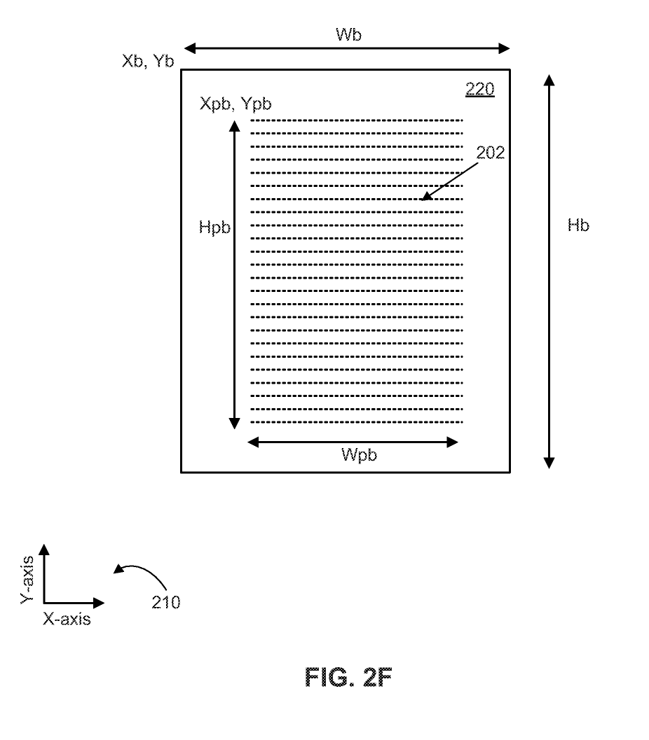

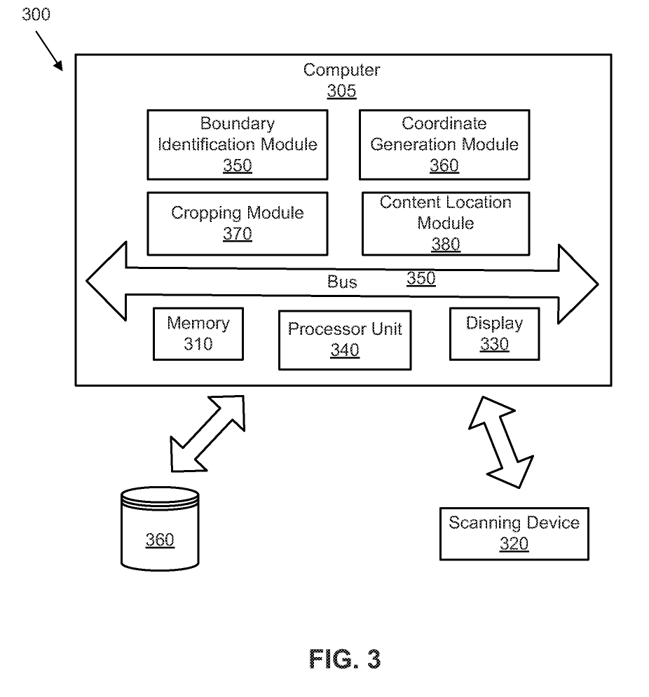

FIG. 1 is discussed in connection with FIGS. 2A-2F and FIG. 3.

FIG. 3 shows a block diagram of a computer system 300 in accordance with an example embodiment of the present invention. The computer system executes methods described herein, including one more of the blocks illustrated in FIG. 1 and FIGS. 2A-2F.

The computer system 300 includes a scanning device 320 and one or more databases or storage devices 360 coupled to computer 305. By way of example, the computer 305 includes memory 310, display 330, processing unit 340, one or more buses 350, and a plurality of modules 350, 360, 370, and 380. The processor unit includes a processor (such as a central processing unit, CPU, microprocessor, application-specific integrated circuit (ASIC), etc.) for controlling the overall operation of memory 310 (such as random access memory (RAM) for temporary data storage, read only memory (ROM) for permanent data storage, and firmware) and executing the modules. The processing unit 340 communicates with memory 310 and modules via one or more buses 350 and performs operations and tasks necessary for executing the modules. The memory 310, for example, stores applications, data, programs, algorithms (including software to implement or assist in implementing embodiments in accordance with the present invention) and other data.

Looking now to FIG. 1, according to block 100, pages of a document are scanned with an electronic device, such as a scanner, to generate a digitized copy or image file of the document. For example, the pages are scanned with scanning device 320 which produces a digitized, electronic, or scanned copy of the document.

By way of example, the digitized document is wholly or partially formatted as an image file. Image files include either pixel or vector (geometric) data that are rasterized to pixels when displayed. Raster formats include: JPEG, TIFF, RAW, PNG, GIF, BMP, PPM, PGM, PBM, XBM, ILBM, WBMP, and PNM. Vector formats include: CGM, and SVG.

As used herein and in the claims, the term “scanning” or “scan” is an action or process of converting text and/or graphics from a document (for example, a paper document, photographic film or paper, or other file) to a digital image.

Further, as used herein and in the claims, the term “document” is a writing or image that conveys information, such as a physical material substance (example, paper) that includes writing using markings or symbols. Documents can be a single page or span many pages and can be based on various medium of expression such as, but not limited to, magazines, newspapers, books, published and non-published writings, pictures, text, etc.

According to block 110, the scanned pages are obtained or received. For example, the scanned pages are stored in the storage device 360 and provided to computer 305.

The scanned pages can be obtained from a scanner (e.g., directly from scanning device 320), memory or storage, received from a transmission (e.g., email), received from a network location (e.g., downloaded from a server), etc.

FIG. 2A shows an example of a scanned page 200 of a document with content 202 (such as text and/or images). The scanned page can include one or more artifacts or anomalies 204A, 204B, and 204C.

As used herein and in the claims, an “artifact” is an error, discrepancy, or deviation in a document. Artifacts and anomalies include, but are not limited to, skewed text or graphics that occurs at the edge of the document (such as at an edge of a book's spine upon being scanned), yellowing or other aging effects, wrinkling, shadows, gutter lines, misalignment of borders, fuzzy or unclear text or graphics, dark spots or lines, gray areas, uneven coloring, and fading.

An X-Y coordinate system 210 is shown to assist in explaining example embodiments.

As shown in FIG. 2A, an anomaly or artifact also occurs along the right margin 212 since this margin was not properly captured in the scan. This margin is too close to an edge or boundary 214 of the page 200. Misalignment of margins often occurs when documents are scanned. One or more of the right, left, top, and bottom margins can become misaligned (i.e., not straight) or increased in size or decreased in size from the scan when compared to the margin in the original document.

In one embodiment, the scanned pages are cropped at a boundary or edge of the page. Content boundaries for each page can also be provided after the scan or calculated. In one embodiment, the boundaries of the document are determined with a boundary identification module 350.

The boundary identification module 350 receives the digitized document page and identifies a content boundary. Various techniques can be used to distinguish the content boundary from a margin region that typically surrounds the content.

According to block 120, coordinates are generated for each of the scanned pages. For example, the coordinates are generated with a coordinate generation module 360.

FIG. 2B shows the scanned page 200 with various coordinates being generated onto the page. For illustration, example coordinates are provided with reference to the X-Y coordinate system 210. These coordinates include locations for both the outer boundaries, edges, or perimeter of the page 200 and the outer boundaries, edges, or perimeter of the content 202 appearing on the page.

The coordinates for the scanned page include, but are not limited to, the following:
Xp: An X-coordinate position of the scanned page. Xp is a boundary that occurs in a top left corner of the scanned page.
Yp: A Y-coordinate position of the scanned page. Yp is a boundary that occurs in a top left corner of the scanned page.
Wp: A width of the scanned page.
Hp: A height of the scanned page.

Locations for the content boundary are also provided. The coordinates for the cropped content of the scanned page include, but are not limited to, the following:
Xc: An X-coordinate position of the identified content. Xc is a boundary that occurs in a top left corner of the cropped content.
Yc: A Y-coordinate position of the identified content. Yc is a boundary that occurs in a top left corner of the identified content.
Wc: A width of the identified content.
Hc: A height of the identified content.

According to block 130, content of the scanned page is cropped. For example, the scanned page is cropped with cropping module 370.

FIG. 2C shows the scanned page 200 after the content 202 is cropped on all four edges. The margins and artifacts are now removed. The content is represented as a clean copy.

According to block 140, create a blank page having a size or dimensions and shape that are equal to the size or dimensions and shape of the original scanned page. In one example embodiment, pages are created with equivalent shapes and sizes.

FIG. 2D shows a blank page 220 that has a size equal to the scanned page 200 in FIG. 2A.

According to block 150, compute a location of the cropped content to be placed onto the blank page. In one embodiment, the location is determined with a content location module 380.

In one embodiment, the cropped content is placed in an equivalent location as the content appeared in the original document. For example, if the content was aligned in a central location (i.e., the content was evenly spaced from the edges of the page) in the original document, then a central location for the content is computed for placement onto the blank page.

According to block 160, the cropped content is placed on the blank page at the location computed in block 150.

FIG. 2E shows content 202 centrally aligned on the blank page 220. The anomalies (shown in FIG. 2A at 204A-204C) have been cleaned and removed. Furthermore, the misalignment of the right margin (shown in FIG. 2A at 212) is corrected.

In one embodiment, the content is placed in a location on the blank page to emulate how the content visually appeared in the original document. By way of example, assume the original document was a book with the following margins:
left margin=A inches;
right margin=B inches;
top margin=C inches; and
bottom margin=D inches.

In this instance, the cropped content of the digital image is placed on the blank page to have margins that are equal to the original document (i.e., left margin=A inches; right margin=B inches; top margin=C inches; and bottom margin=D inches).

In one embodiment, the location to place the cropped content occurs as shown in FIG. 2F. The blank page 220 is assigned the following coordinates:
Xb: An X-coordinate position of the blank page. Xb is a boundary that occurs in a top left corner of the blank page.
Yb: A Y-coordinate position of the blank page. Yb is a boundary that occurs in a top left corner of the blank page.
Wb: A width of the blank page.
Hb: A height of the blank page.

The position of the cropped content 202 on the blank page is assigned the following coordinates:
Xpb: An X-coordinate position of the content boundary on the blank page.
Ypb: A Y-coordinate position of the content boundary on the blank page.
Wpb: A width of the content boundary.
Hpb: A height of the content boundary.

The widths of the left and right margin are equally split as follows:

Xpb=(Wpb−Wb)/2.

Splitting the margin equally positions the cropped content in a center of the blank page along the X-axis such that

Wpb=Wb; and

Hpb=Hb.

Here, the resulting page is center aligned on the X-axis and positioned on the Y-axis as it appeared in the original document.

According to block 170, the digital copy is stored, displayed, transmitted, or further processed. For example, once the cropped content is aligned on the blank page, it can be viewed at a display of a computer, presented at a website for purchase, or printed and bound to replicate the original document. Furthermore, the digital copy can be sold and downloaded.

In order to be able to print the final digital document as part of a book, some printers require that there be more margin space on the left side for right side pages and more margin on the right side for pages that appear on the left side of a book. To compensate for these margins, one embodiment centers the blank page on another blank page that is wider on the X-axis by an amount equal to or greater than twice the increased margin space required. This added margin enables the printer to trim the page appropriately before binding the pages together to reproduce the book.

One embodiment properly aligns cropped content on clean pages while preserving the original position and also processes document collections such that all pages are properly aligned regardless of whether such pages are viewed on a computer monitor or printed out, such as being printed as a book.

When a single scanned page of a document needs to be aligned, an assumption is made that the blank page size is equivalent in size and shape to the original scan page. Often, however, the scans of a document include a collection of scanned pages from a single source, such as a book or a magazine. In such a scenario, the scanned raw pages may not be the same size. If the size varies on the X-axis, the method discussed in FIG. 1 is applicable. If, however, the page sizes differ on the Y-axis, an additional step is provided to preserve the original content position.

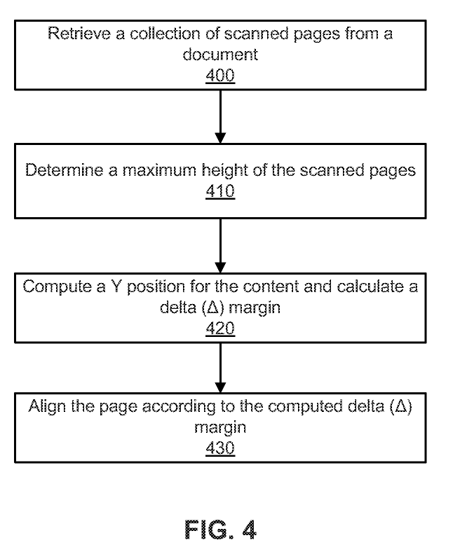

FIG. 4 illustrates a method to address the issue when the page sizes differ on the Y-axis.

According to block 400, a collection of scanned pages from a document is retrieved.

According to block 410, a determination is made of a maximum height of the pages in the collection of scanned pages. For example, given a collection of scanned pages, determine the maximum height among the given collection as follows:
Let Hp: be the height of current page;
Compute Hmp: The max height in the collection.

According to block 420, compute the Y position for the content and calculate a delta (Δ) margin. For example, the Y position of the content is computed as follows:

Ypb=Yc−MΔ.

Here, margin delta MΔ is computed as follows:

MΔ=(Hmp−Hp)/2.

According to block 430, align the page according to the computed delta (Δ) margin.

This process allows an embodiment to properly align cropped content on clean pages while preserving the original position and also process document collections such that all pages are properly aligned weather they are viewed oh a computer monitor or printed out as a book.

In one example embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with example embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit the invention.

In some example embodiments, the methods illustrated herein and data and instructions associated therewith are stored in respective storage devices, which are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the various embodiments in accordance with the present invention, embodiments are implemented as a method, system, and/or apparatus. As one example, example embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known physical and tangible media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method executed by a computer, comprising:
obtaining a scanned page of an original page of a document that includes content and an artifact;
cropping the scanned page to remove the artifact and margins around the scanned page to generate cropped content; and
placing the cropped content on a blank page to reproduce a copy of the original page.

2) The method of claim 1 further comprising, generating coordinate positions for outer boundaries of both the scanned page and the content in the scanned page.

3) The method of claim 1, wherein the scanned page is cropped to remove margins around four sides of the scanned page.

4) The method of claim 1 further comprising:
generating the blank page to have a size and shape of the original page;
placing the cropped content in a center of the blank page.

5) The method of claim 1, wherein the cropped content is placed on the blank page in a location that emulates a location of the cropped content on the original page.

6) The method of claim 1 further comprising:
calculating a width of the blank page;
calculating a width of the cropped content;
determining a difference between the width of the blank page and the width of the cropped content;
dividing the difference by two to determine a left and right margin for cropped content on the blank page.

7) The method of claim 1 further comprising, correcting for a misalignment of a margin on the scanned page by cropping the scanned page to remove the margin.

8) A computer, comprising:
a cropping module that crops a scanned page of a document to remove a misaligned border and generate cropped content;
a content location module that determines a location to place the cropped content on a blank page to emulate a copy of the document; and
a processor that executes the cropping module and the content location module.

9) The computer of claim 8, wherein the cropped content has margins removed from four sides of the scanned page.

10) The computer of claim 8 further comprising a coordinate generation module that generates coordinate positions on the scanned page for an outer perimeter of both the scanned page and the cropped content.

11) The computer of claim 8, wherein the cropping modules crops the scanned page to remove an artifact occurring along a margin of the scanned page.

12) The computer of claim 8, wherein the cropping modules crops the scanned page to correct for a misaligned margin occurring on the scanned page.

13) The computer of claim 8, wherein the cropped content is placed in a center of the blank page.

14) The computer of claim 8, wherein the blank page has an equivalent size and shape of the document so the cropped content on the blank page emulates an original version of the document.

15) A tangible computer readable storage medium having instructions for causing a computer to execute a method, comprising:
receive a digital copy of a document that includes content and an artifact;
crop the digital copy to remove the artifact and margins around digital copy to generate cropped content; and
align the cropped content on a blank page to reproduce a copy of the document.

16) The tangible computer readable storage medium of claim 15 further comprising:
determining an X-coordinate position of the digital copy;
determining a Y-coordinate position of the digital copy;
determining a width of the digital copy;
determining a height of the digital copy.

17) The tangible computer readable storage medium of claim 15 further comprising:
determining an X-coordinate position of the cropped content;
determining a Y-coordinate position of the cropped content;
determining a width of the cropped content;
determining a height of the cropped content.

18) The tangible computer readable storage medium of claim 15 further comprising:
determining a maximum height of pages in the document;
calculating a difference between a height of one page and the maximum height;
using the difference to align the one page on the blank page.

19) The tangible computer readable storage medium of claim 15 further comprising, aligning the cropped content on the blank page to visually emulate the document.

20) The tangible computer readable storage medium of claim 15, wherein the document is a scanned book.
